(19) United States
(12) Patent Application Publication
(10) Pub. No.: US 2010/0180480 A1
(43) Pub. Date: Jul. 22, 2010

(54) Talking Yard Sign

(76) Inventor: Keyvan Mehrabi-Nejad, North York (CA)

Correspondence Address: Nasser Ashgriz;Heydary Hamilton PC, Suite 1200, 439 University Ave, Toronto, ON, M5G 1Y8, CA

(21) Appl. No.: 12/356,458

(22) Filed: Jan. 20, 2009

(51) Int. Cl. G09F 7/00; G09F 15/00; G06Q 30/00

(52) U.S. Cl. 40/607.01; 40/584; 705/14.4

(57) ABSTRACT

A talking yard sign is disclosed, which comprises of a yard sign having a digital recorder and playback system. The object of the present invention is to provide more information related to the sign in audio or video format. The audio/video device attached to the sign comprises of a microphone which records the audio information from the buyer, a speaker, which can play back the message from the agent/owner of the sign and also a display panel which plays the messages from the agent/owner of the sign and a removable recordable devise to save the recorded messages.

### FIELD OF THE INVENTION

This invention pertains generally to a yard sign having recording and playback capabilities to record and play back messages and information related to the sign.

### BACKGROUND OF THE INVENTION

Billboards, sign boards and yard signs play a very important role in the fields of advertisement and marketing. A particular advertisement on a billboard or a sign board can reach a large number of people. Usually these billboards are placed along side the roads or places which are highly populated like shopping malls, market yards, parking lots etc. The advertising and marketing techniques using billboards, sign boards or yard signs are economical and efficient. Among numerous applications of yard sign are house or yard for sale signs, political signs, and garage sales signs.

Yard signs are made in several different ways. Very inexpensive yard signs are made of printed plastic sheets. Others are made of printed sheet of cardboard stapled to a wooded boards or glued to metal boards. The boards have legs to insert into the ground. Another type of yards sings is made from corrugated board or plastic as disclosed in U.S. Pat. Nos. 5,042,183, 4,894,937 and 5,307,580.

Although a large number of businesses use bill boards or sign boards for advertising, the real estate business uses them the most. In real estate business, the real estate agent or home owner who would like to sell a property or a house usually places a board or a sign in the yard, thus termed “yard sign”. These yard signs usually display the information of the real estate agent or the owner of the property, contact number or a company which represents the property. A passerby who is interested in the property has to call the number on the sign and contact the agent or owner of the property for more information. The majority of calls are for obtaining information and do not proceed further. Therefore, agents and owners spend a great amount of time answering calls from non-serious callers. Still, yard signs are very popular advertisement method because they are quite inexpensive.

The main drawback of the yard sign is that they do not provide all the information and details about the property. This is mainly due to space constraints on the board, as well as having to make special yard sign for each property. It is very important in a real estate business, to update a buyer about details of the property like the size of the property, number of rooms, spaces, neighborhood, uniqueness, price, etc. The potential buyer has to call the agent or the owner for such information. In addition, the number of homes sold by the owners have also increased dramatically. The homes sold by the owner are usually not listed on computer systems and therefore the details of their information is not available to the potential buyers.

In order to overcome the forgoing issues with yard signs, several novel techniques are utilized in the real estate business for promoting the sales. One method to provide more information on the sign is disclosed in U.S. Patent Application 2007/0209258 by Zazworsky, which provides a yard sign that has an information storing and dispensing unit which holds materials such as property pamphlets and photographs. This method, although effective, requires printing of the material and locating it next to the sign. The agent needs to replace the material every so often and make sure that there are enough material for certain period of time. If the material is not replace on time, there is no source of information. Another system for providing property information is disclosed in U.S. Patent Application 2006/0194572 by Fresonke et al. They provide a short code on the yard sign. The interested party requests the property information by sending a message with a wireless device and using the short code provided on the sign to a central computer. The central computer will then send the property information to the interested party's wireless device. This system requires an elaborate information network, which may not be feasible for many agents and owners.

Another method of providing more information on the property is by a system called “Talking House”, which uses a radio transmitter that is placed in a home or property to be sold. This radio-transmitter has a message about the house or property to be sold. When buyers pass the yard sign in front of the house or property, they can “tune in” their car radio to the frequency mentioned on the yard sign and listen to the details about the house. This radio-transmitting system can be purchased or rented from the manufacturers of “Talking House”. Although this method is novel, it is very expensive for the small retailers in this business or home owners who wish to sell their properties with out the help of real estate agents.

### SUMMARY OF THE INVENTION

In view of the foregoing disadvantages inherent in the known types of yard signs, the herein taught art provides improvement by a simple, integral, and more advantageous audio, video recording and playback systems.

The object of present invention is to develop a yard sign, which provides a user/buyer with more information about the product, property, or any other matter that may be of interest to the customer. The sign can also record customer's information, inquiries and questions to be heard by the agent or owner of the sign.

The other object of the present invention is to provide a method which is efficient and economical for small businesses and home owners who would like to sell their property.

The other object of present invention is to provide an audio control device consisting of a microphone which records the audio information from the buyer, a speaker, which can play back the message from the buyer and also a control panel which plays the message from the retailer and a recordable devise to retrieve it.

The other object of the present invention is to convert the existing yard signs to “Talking Yard Signs” by inserting or attaching to them the above audio control device.

The other object of the present invention is to provide an easy and inexpensive method of marketing. A buyer looking for a property driving or walking around the talking yard sign can obtain the details of the property by just pressing a button which would play a prerecorded message about the property. In addition, the buyer can record a message and a contact number which can be later retrieved by the yard sign owner.

### BRIEF DESCRIPTION OF THE DRAWINGS

In the figures, which illustrate, by way of example only, embodiments of the present invention,

FIG. 1 is a perspective view of a yard sign having an audio recording system;

FIG. 2 is a perspective view of a yard sign having an audio-visual system; and

FIG. 3 is a perspective view of a yard sign having an audio system on its post.

### DETAILED DESCRIPTION OF THE INVENTION

Yard signs are made of a variety of material including synthetic resin and foam, plywood, plastic, etc. The more common material is synthetic resin which is relatively inexpensive. The yard signs are typically rectangular having a certain thickness, usually less than a centimeter. In one embodiment of the present invention, a recording system can be attached to any billboard or yard sing with simple attaching means. For instance, an opening can be made inside the foam of the yard sign, and the recording system can be inserted into the opening and sealed.

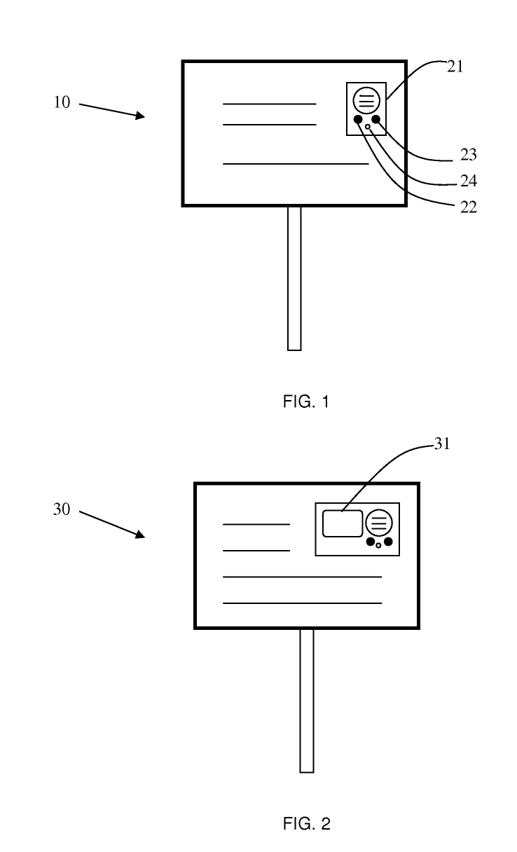

FIG. 1 illustrates a talking yard sign 10 having a board 11 and a post 12. An audio recording device 20 is attached to the board 11. The yard sign may contain standard information found on standard yard signs, such as the name of the agent or the owner and the contact information. In addition, the talking yard sign has a recording device 20 which may have various features. A simple recording device may only play back the messages prerecorded by the agent or the owner of the sign. The message can be heard through a speaker 21 once the switch 22 is pressed. This recording system is a simple and inexpensive one which can only provide information and cannot record messages from the user and potential buyer of the property.

Such audio recording systems are available in variety of designs and sizes and use variety of technologies. If a substantially rigid sign, such as a wooded or a metal sign, is used, basically any type of recording device can be connected to it. If a plastic sign is used, the recording device has to be small and should not weigh much. Such small and miniature recording systems are used in cards with built-in record/playback capability as disclosed in U.S. Pat. No. 4,791,741. Also U.S. Pat. No. 3,462,157 to Barnett, et al. discloses an audible greeting card, comprising a pair of panel members, first one with a sound track and the second one with a pick-up member and an amplifier. U.S. Pat. No. 4,222,188 to Tarrant and Parsons discloses a sound reproduction device and insignia supporting unit, which discloses the way of amplifying sound which is recorded. All such systems can be incorporated in the present system.

The recording device can be removably or permanently attached or mounted to the sign by variety of means, such as bolt, screws, rivets, or glued on. The device can also be inserted into the sign. The recording device can even be fixed on the sign using magnets.

The audio device can be powered by battery, an electric outlet, solar energy, or any other sources of power that may be in the vicinity of the yard sign. Since the yard signs are exposed to the ambient conditions, the electronic devices need to be insolated to prevent damages due to humidity, rain, etc.

A simple recording device has a microphone, record/playback switches, a speaker, and batteries. Switches can be as simple as fixed contact wires. A control pin can be used to choose power, record or playback modes of the switches. Any type of recoding means can be used in the present device. These may include digital audio/video recoding systems, tapes, CD-ROMs and USB cable devices. The device may also have detachable electronic memory that stores electronic signals and a mechanism of retrieving signals from the memory.

In another embodiment of the same invention, system may also have a capability to record message by the user or the interested parties, in addition to recording messages by the owner/agents. A second button 23 can be pushed and held to record the messages by the users. A user can speak into a microphone 24 to record his/her message.

Other methods of retrieving information can also be used. These include remote control of the playback device. Such remote control device may be a sensor or iCLASS key, known in the art, and which are typically used to open doors remotely. Such keys can be obtained from the agent or the owner of the sign. By placing the key close to the playback device the device is activated and play the message.

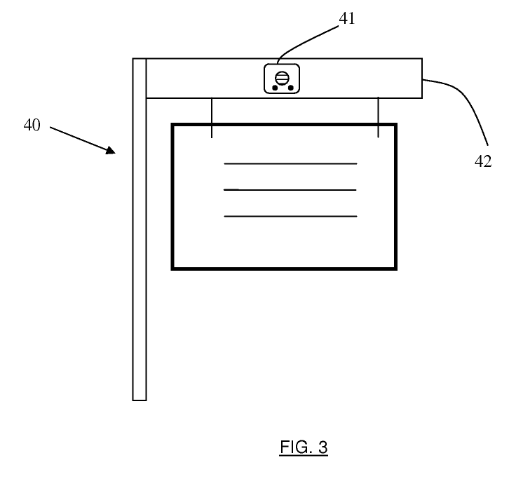

In another embodiment of the same invention 30, the sign has a monitor 31 illustrated in FIG. 2. The monitor is used to provide a virtual tour of the house or to provide information visually. Use of a monitor for visual display of the property is expensive and may require installation of security systems. However, such security systems are already known to the art and may include alarm systems in case of tampering with the device or removal of the sign.

The audio and/or video recording and playing systems can also be located on the post itself. Many of the yard signs use more permanent posts on which they hang the sign. Posts come in a variety of designs and constructed from variety of materials, such as wood or metal. A recoding system can be removably or permanently connected to a post. FIG. 3 illustrates one such talking yard sign 40 in which an audio recording system 41 is fixed to the upper part of the post 42.

In another embodiment of the present system, the sing or the post may have a location to put business cards. Both the agent/owner as well as the interested parties may leave their business cards. A simple pocket made on the sign or a tray fixed on the sign can be used to place business cards. The tray or the business card holder can also be located on the post. A business card is an easy way of taking down the information of the agent/owner. If an interested party listens to the audio system on the sign and would like to setup an appointment to see the house, he/she can take a business card located on the sign for future contact.

What is claimed is:

1. A talking yard sign comprising: an audio messaging device having a power source, whereby various pre-recorder messages, announcements and information can be broadcasts by the sign.

2. A talking yard sign of claim 1, wherein said sign having a board and said audio messaging device is attached to the board.

3. A talking yard sign of claim 1, wherein said sign having a board and a post; said board connected to the post; and said audio messaging device is attached to the post.

4. A talking yard sign of claim 1 further comprising an activation device, whereby the recorded information is announced only after activation.

5. A talking yard sign of claim 1, wherein said activation device is a pushbutton switch, which is activated by the user.

6. A talking yard sign of claim 1, wherein said activation device is a motion detector, which activates the system when a person walks by a close vicinity of the sign.

7. A talking yard sign of claim 1, wherein said activation device is a remote key, whereby the users having the key can activate the device while sitting in their cars and whereby such keys can be obtained from agents or owner.

8. A talking yard sign of claim 1 further comprising of means for recording messages by the user, whereby any user can leave messages on the recording device for the owner/agent of the sign.

9. A talking yard sign of claim 8, wherein said means for recoding messages by the user is detachable, whereby the owner/agent can detach said means for recoding message.

10. A talking yard sign of claim 1 further comprising means for visual and video display of information.

11. A talking yard sign of claim 1 further comprising means to place business cards.

12. A talking yard sign for a real estate purposes comprising:
a. a yard sing having the real estate agent's information;
b. means for recoding information provided by the sign owner or agent;
c. means for playing back said recorded information comprising a speaker;
d. means to record information provided by the user or the interested party comprising a microphone;
e. means to retrieve the recorded information; and
f. battery means.

13. A talking yard sign for real estate purposes of claim 12 further comprising means for visual and video display system to visually display information on said property.

14. A method of advertisement for a real estate property using a talking sign comprising:
a. installing a yard sing in the close vicinity of a property to be sold or leased;
b. said yard sign having a prerecorded messaging device;
c. said messaging device having a prerecorded message providing information on the property;
d. said messaging device being able to record messages from the potential buyer or user; and
e. said messaging device is activated by the user.
